(19) United States
(12) Patent Application Publication
(10) Pub. No.: US 2011/0044505 A1
(43) Pub. Date: Feb. 24, 2011

(54) EQUIPMENT OPERATION SAFETY MONITORING SYSTEM AND METHOD AND COMPUTER-READABLE MEDIUM RECORDING PROGRAM FOR EXECUTING THE SAME

(75) Inventors: Myo-Taeg LIM, Seoul (KR); Shin-Suk PARK, Seongnam-si (KR); Dae-Hie HONG, Anyang-si (KR); Dong-Gi WOO, Seoul (KR); Yun-Geun CHOE, Yongin-si (KR); Young-Joong KIM, Seoul (KR)

Correspondence Address: CANTOR COLBURN LLP, 20 Church Street, 22nd Floor, Hartford, CT, 06103, US

(73) Assignee: KOREA UNIVERSITY INDUSTRY AND ACADEMY COOPERATION, Seoul (KR)

(21) Appl. No.: 12/859,374

(22) Filed: Aug. 19, 2010

(30) Foreign Application Priority Data
Aug. 21, 2009 (KR) 10-2009-0077397

(51) Int. Cl. G06K 9/00

(52) U.S. Cl. 382/103

(57) ABSTRACT

Provided are equipment operation safety monitoring system and method and computer-readable medium having a program recorded thereon, the program allowing a computer to execute the method. The equipment operation safety monitoring system includes an image input unit, an integrated image generation unit, a guideline generation unit, and an image output unit. The image input unit is mounted on heavy equipment and inputs a plurality of images acquired by photographing partitioned areas in all the directions around the heavy equipment. The integrated image generation unit generates an integrated image including the areas in all the directions around the heavy equipment by using the plurality of the images. The guideline generation unit generates a guideline indicating a position separated by a predetermined distance from the heavy equipment. The image output unit illustrates the guideline on the integrated image and outputs the integrated image.

### BACKGROUND

1. Technical Field

The present invention relates to a heavy equipment monitoring system and method, and more particularly, to a system and method of monitoring operation safety of a heavy equipment.

2. Related Art

Heavy equipment collectively refers to machinery having a heavy weight which is used for civil engineering, construction, and the like. As examples of the heavy equipment, there are an excavator, a bulldozer, a forklift truck, and the like. In general, a driver of such heavy equipment operates the heavy equipment while monitoring the surroundings of the heavy equipment by using several mirrors such as a rear view mirror disposed in the operating room and left and right side view mirrors. However, there exist blind zones which cannot be monitored by the driver sitting on the driver's seat. Therefore, the blind zones cause serious problems in the safe operation of the heavy equipment.

Conventionally, in order to prevent accidents caused by the blind zones, assistant's manual signaling or RF transmission may be used. In this case, there is a problem in that the assistant's safety may not be secured. In addition, the assistant cannot also monitor the blind zones of the heavy equipment such as an excavator.

As one of the approaches for solving these problems, a technology of monitoring blind zones by using cameras has been researched and used. As examples, a rear side monitoring camera is used for a vehicle, and a long-distance camera is used for a crane. For example, a rear side of an upper rotating structure is photographed by a camera attached to an upper rear portion thereof, and a photographed image is allowed to be seen by the driver, so that the rear side of the upper rotating structure can be entirely monitored.

However, in this method, only the image in the direction of the camera can be monitored, so that there is a limitation in monitoring the entire surroundings of the driver. In addition, there is a problem in that a distance between the driver and an obstacle is hard to estimate. This is because it is difficult to accurately estimate the distance by using only the two-dimensional image photographed by the camera. In order to solve the problem, a separate apparatus may be used for distance measurement. However, there is a problem in that additional cost is required and a space for installation of the separate apparatus needs to be secured.

### SUMMARY

The present invention is to provide an equipment operation safety monitoring system capable of entirely monitoring work environment of the heavy equipment without a separate assistant and intuitively perceiving a distance between an approaching object and the heavy equipment without a separate distance measurement apparatus.

According to an aspect of the present invention, there is provided an equipment operation safety monitoring system including an image input unit, an integrated image generation unit, a guideline generation unit, and an image output unit.

The image input unit is mounted on heavy equipment and inputs a plurality of images acquired by photographing partitioned areas in all the directions around the heavy equipment. The integrated image generation unit generates an integrated image including the areas in all the directions around the heavy equipment by using the plurality of the images. The guideline generation unit generates a guideline indicating a position separated by a predetermined distance from the heavy equipment. The image output unit illustrates the guideline on the integrated image and outputs the integrated image.

In this manner, the integrated image including the images in all the directions around the heavy equipment is generated, so that it is possible to entirely monitor work environment of the heavy equipment without a separate assistant. In addition, the image on which the guideline is illustrated is output, so that it is possible to intuitively perceive a distance between an approaching object and the heavy equipment without a separate distance measurement apparatus.

The integrated image generation unit may generate the integrated image by correcting the input images according to a characteristic of the image input unit. According to such a configuration, even in a case where the image input unit employs a wide angle camera or the like, it is possible to provide an image which a user can easily perceive.

In addition, the equipment operation safety monitoring system may further include an approaching object determination unit which determines whether or not there is an object approaching the heavy equipment by comparing the images input by the image input unit with previously input images. According to such a configuration, in the case where there is an object approaching the heavy equipment, a corresponding operation can be performed.

In addition, the equipment operation safety monitoring system may further include a warning signal output unit which outputs a warning signal in the case where the approaching object determined by the approaching object determination unit is within a predetermined distance from the heavy equipment. According to such a configuration, in the case where a user may not perceive an approaching object, it is possible to ensure operation safety of the heavy equipment.

In addition, the integrated image generation unit may generate the integrated image in a top view format as seen from the top of the heavy equipment. The guideline generation unit may generate the guideline based on an installation height and angle of the image input unit.

According to another aspect of the present invention, there is provided an equipment operation safety monitoring method corresponding to the above system. According to still another aspect of the present invention, there is provided a computer-readable medium having a program recorded thereon, the program allowing a computer to execute the above equipment operation safety monitoring method.

According to the present invention, an integrated image including images in all the directions around heavy equipment is generated, so that it is possible to entirely monitor work environment of the heavy equipment without a separate assistant. In addition, an image on which a guideline is illustrated is output, so that it is possible to intuitively perceive a distance between an approaching object and the heavy equipment without a separate distance measurement apparatus.

In addition, even in a case where an image input unit employs a wide angle camera or the like, it is possible to provide an image which a user can easily perceive.

In addition, in the case where there is an object approaching the heavy equipment, a corresponding operation can be performed.

In addition, in the case where a user may not perceive an approaching object, it is possible to ensure operation safety of the heavy equipment.

### BRIEF DESCRIPTION OF THE DRAWINGS

The present invention will be described with reference to the accompanying drawings, wherein like numbers reference like elements.

FIG. 1 is a schematic block diagram illustrating an equipment operation safety monitoring system according to the present invention.

FIG. 2 is a view illustrating a two-dimensional image ground coordinate model represented by the equipment operation safety monitoring system of FIG. 1.

FIG. 3 is a view illustrating a configuration of image data of guidelines as a result obtained by the image ground coordinate model of FIG. 2.

FIG. 4 is a view illustrating an example of a usage state of the equipment operation safety monitoring system of FIG. 1.

FIG. 5 is a schematic flowchart illustrating a method of monitoring surroundings around heavy equipment such as an excavator according to an embodiment of the present invention.

FIG. 6 is a view illustrating a step of converting images, of which distortions are corrected, into an image in a top view format.

FIG. 7 is a schematic flowchart illustrating a monitoring method performed in the equipment operation safety monitoring system of FIG. 4.

FIG. 8 is a schematic flowchart illustrating a step of generating guidelines in the top view image obtained in FIG. 6.

FIG. 9 is a view illustrating an example of generating guidelines in a top view image.

FIG. 10 is a schematic flowchart illustrating a warning of approaching step for warning of approaching of an object by using a difference between real-time input images.

FIG. 11 is a schematic view illustrating an example of an approaching object determination unit which determines an approaching object.

FIG. 12 is a view illustrating an example of a screen of a display for a manipulator.

### DESCRIPTION OF EXEMPLARY EMBODIMENTS

Hereinafter, exemplary embodiments of the present invention will be described with reference to the accompanying drawings.

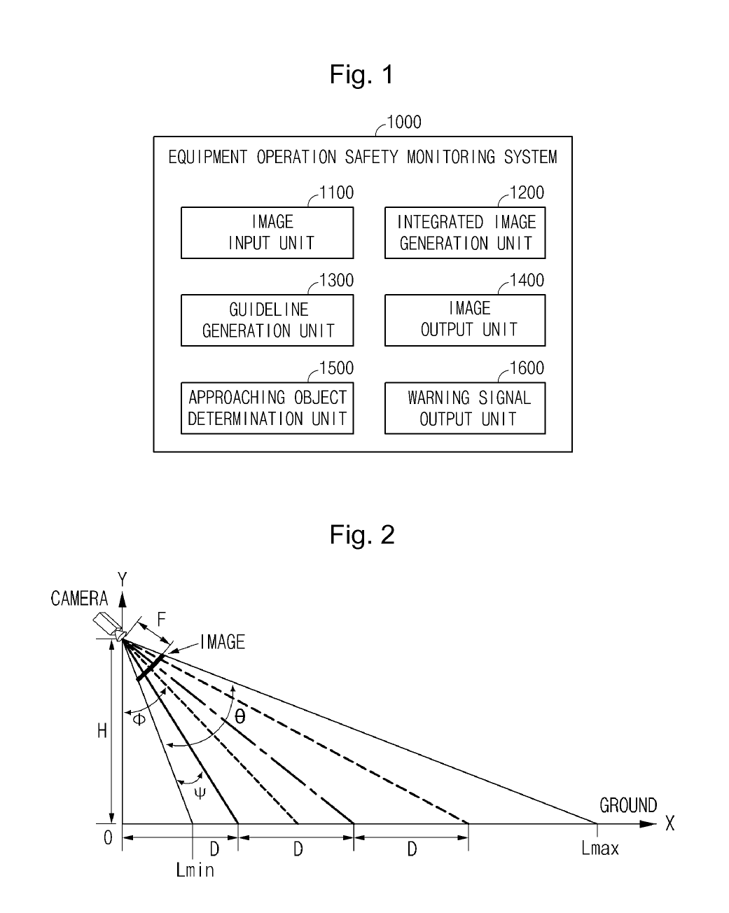

FIG. 1 is a schematic block diagram illustrating an equipment operation safety monitoring system according to the present invention.

In FIG. 1, the equipment operation safety monitoring system 1000 includes an image input unit 1100, an integrated image generation unit 1200, a guideline generation unit 1300, an image output unit 1400, an approaching object determination unit 1500, and a warning signal output unit 1600.

The components of the equipment operation safety monitoring system 1000 may be configured in a hardware manner. In addition, the components may be configured in a software manner. In this case, the software may be provided in form of a computer readable program stored in a storage medium.

The image input unit 1100 is mounted in a heavy equipment to input a plurality of images acquired by photographing partitioned areas in all the directions around the heavy equipment. Although the image input unit 1100 may input the images by sequentially photographing the partitioned areas of the directions by using a single camera, the image input unit 110 generally inputs the plurality of the images by using a plurality of cameras which photograph the partitioned areas at the predetermined angles.

The integrated image generation unit 1200 generates an integrated image including the areas in all the directions around the heavy equipment by using the plurality of the images. The integrated image is a single output image including the plurality of the images with respect to the heavy equipment. Due to the integrated image, the driver of the heavy equipment can check the surroundings of the heavy equipment at a single glance.

At this time, the integrated image generation unit 1200 can generate the integrated image by correcting the input images according to a characteristic of the image input unit 1100. In this case, the integrated image generation unit 1200 corrects input image information according to a predetermined characteristic of the image input unit 1100.

For example, the image input unit 1100 may input the images by using a wide angle lens such as a fisheye lens. In this case, the input images may be corrected before the output thereof so that a user can easily perceive the images.

According to such a configuration, although a wide angle camera or the like is employed in the image input unit, it is possible to provide images which can be easily perceived by a user.

The guideline generation unit 1300 generates a guideline indicating a position separated by a predetermined distance from the heavy equipment.

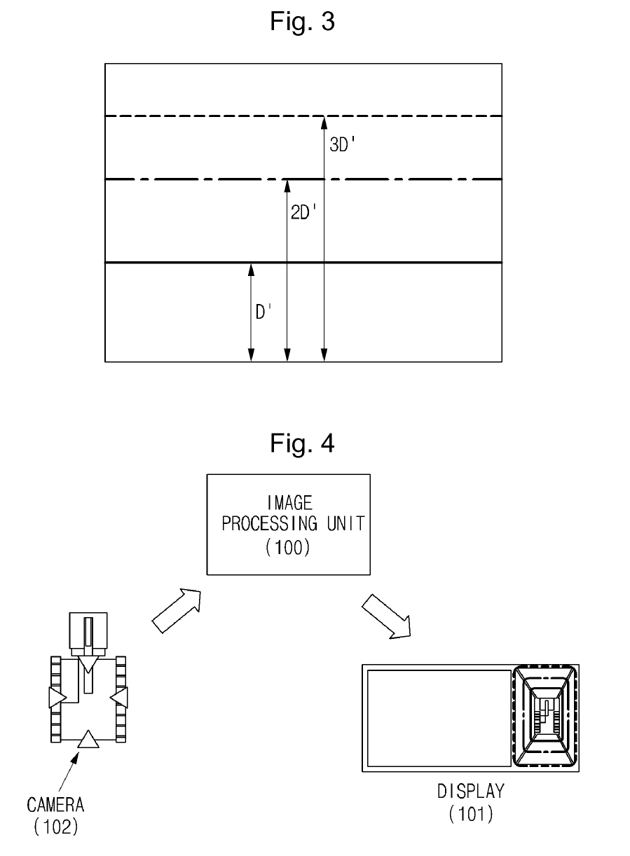

FIG. 2 is a view illustrating a two-dimensional image ground coordinate model represented by the equipment operation safety monitoring system of FIG. 1. FIG. 3 is a view illustrating a configuration of image data of guidelines as a result obtained by the image ground coordinate model of FIG. 2.

Herein, X is a coordinate of a position in the direction of the ground, and Y is a coordinate of the position in the direction vertical to the ground. D is a minimum value of a work radius of the heavy equipment, which is input in the system information input step. F, H, θ, and Φ are a focal length, an installation height, a vertical wide angle, and a pitch angle of a camera, which are input in the camera information input step. An unknown included angle Ψ is obtained by the following method.

First, the position of the ground corresponding to the uppermost side of the image is denoted by Lₘₐₓ, and the position of the ground corresponding to the lowermost side of the image is denoted by Lₘᵢₙ. The values of the Lₘₐₓ and the Lₘᵢₙ are calculated by the following equations.

Lₘᵢₙ=H tan(Φ−0.5θ) (1)

Lₘₐₓ=H tan(Φ−0.5θ) (2)

The D is an arbitrary variable minimum value of a work radius of the heavy equipment. The value of the D can be calculated based on the values input in the system information input step.

ψ=arctan(D/H)−(Φ−0.5θ) (3)

A distance D′ on the image, which is photographed based on the coordinates of the image and the ground illustrated in FIG. 2, corresponding to the separation distance D from the heavy equipment is obtained as follows. Herein, the D is a real distance on the ground, and the D′ is a distance on the image.

D′=F tan(ψ) (4)

In addition, ψ is obtained by substituting 2D for the D in Equation (3), and after that, 2D′ can be obtained by substituting ψ in Equation (4). In the same manner, 3D′ can be obtained.

The image output unit 1400 illustrates the guideline on the integrated image and outputs the integrated image. In this manner, the integrated image including the images in all the directions around the heavy equipment is generated, so that it is possible to entirely monitor work environment of the heavy equipment without a separate assistant. In addition, the image on which the guideline is illustrated is output, so that it is possible to intuitively perceive a distance between an approaching object and the heavy equipment without a separate distance measurement apparatus.

The approaching object determination unit 1500 determines whether or not there is an object approaching the heavy equipment by comparing the images input by the image input unit with previously input images. According to such a configuration, in the case where there is an object approaching the heavy equipment, a corresponding operation can be performed. The corresponding operation is set to the system 1000 in advance. For example, the outputting of the existence of the approaching object to the screen of the image output unit 1400 or the like may be the corresponding operation.

The warning signal output unit 1600 outputs a warning signal in the case where the approaching object determined by the approaching object determination unit 1500 is within a predetermined distance from the heavy equipment. According to such a configuration, in the case where a user may not perceive an approaching object, it is possible to ensure operation safety of the heavy equipment. The warning signal may be configured as a signal output to the driver of the heavy equipment. Otherwise, the warning may be configured as a signal output to the soundings of the heavy equipment.

FIG. 4 is a view illustrating an example of a usage state of the equipment operation safety monitoring system of FIG. 1.

In FIG. 4, the image input unit 1000 is configured with cameras 102; the integrated image generation unit 1200 and the guideline generation unit 1300 are configured with an image processing unit 100; and the image output unit 1400 is configured with a display 101.

The image processing unit 100 combines the images acquired by a plurality of cameras to convert the images into an image in a top view format. In addition, the image processing unit 100 also performs correction of the distortions occurring in this step. An image which seems to be taken by aerial photography can be acquired by the camera mounted on construction equipment. Therefore, it is possible to more intuitively estimate the distance from an obstacle. In addition, it is possible to overcome a limitation in that aerial photography cannot be easily performed in the actual case. Due to the correction of distortions, it is possible to remove a factor which is caused by the distortions of the photographed images to interfere with the driver's determination of environment.

In addition, since the image processing unit 100 outputs the image on which work guidelines indicating predetermined separation distances are illustrated, the driver is allowed to effectively perceive the work radius or the boundary distance without a separate expensive apparatus, so that it is possible to improve work efficiency and to prevent safety accidents.

The approaching warning unit (not shown) using a difference between the images compares the images which are input as time elapses from the time when the heavy equipment such as an excavator is in the stopped state. If a great difference occurs between the previous image and the current image, an object is determined to approach, and the approaching of the object is notified to the driver. Therefore, it is possible to prevent a safety accident that may occur when the driver neither monitors the image nor perceives the approaching object.

The guide line is illustrated on the virtual top view image in the display 101, so that the driver is allowed to intuitively monitor the surroundings.

Although not clearly illustrated in FIG. 4, the camera installed in the heavy equipment such as an excavator may be provided with a fisheye lens for obtaining a wide viewing angle. The recovery of the distorted image caused by the use of the fisheye lens may be implemented in a software manner.

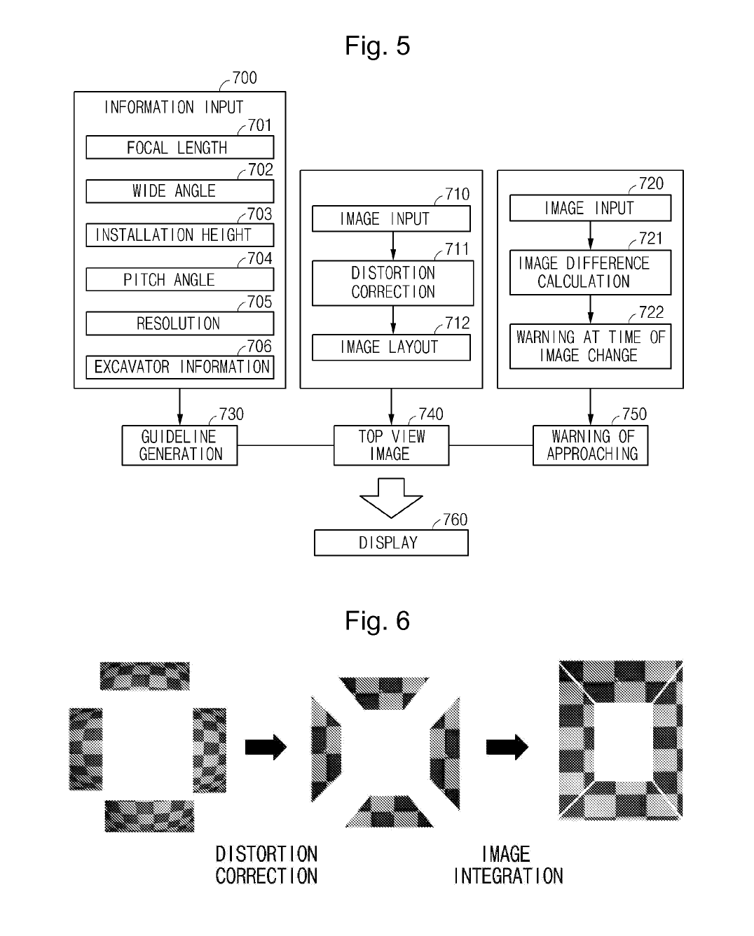

The equipment operation safety monitoring system 1000 according to the embodiment performs steps of FIG. 5. FIG. 5 is a schematic flowchart illustrating a method of monitoring surroundings of heavy equipment such as an excavator according to an embodiment of the present invention.

In a camera information input step 700, camera information such as a focal length, a wide angle, and an installation height of a camera installed in the heavy equipment such as an excavator is input.

In a barrel distortion correction step 711, barrel distortion caused by the use of the wide angle lens is corrected by a barrel distortion correction algorithm illustrated in FIG. 6 based on the information on the camera input in the above step.

In the image integrated step 740, the corrected images are integrated into an image in a top view format. More specifically, the corrected images generated in the aforementioned barrel distortion correction step are integrated into the image in the top view format as seen from the upper portion of the heavy equipment such as an excavator.

In an integrated image conversion mapping table generation step (not shown), in order to solve a problem of a decrease in a speed of calculation which may occur in the above step, a mapping table is generated to increase the speed of calculation.

The image obtained in the above step is output to the screen in the image output step, so that the driver of the heavy equipment such as an excavator can monitor the surroundings of the heavy equipment such as an excavator (760).

FIG. 4 illustrates installation of cameras acquiring input images used to generate an image in a top view format. The images are prospectively projected according to a viewing distance unique to each camera. A distortion correction algorithm illustrated in FIG. 6 is used to correct distortions of the images caused by the perspective projection

FIG. 6 is a view illustrating a step of converting images, of which distortions are corrected, into an image in a top view format. Four images are disposed at suitable positions. Namely, the four images are disposed at front, rear, left, and right positions, so that a single integrated image seems to be seen.

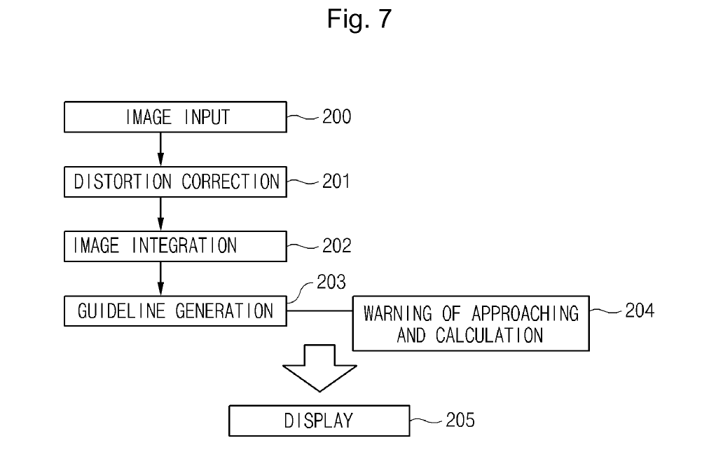

FIG. 7 is a schematic flowchart illustrating a monitoring method performed in the equipment operation safety monitoring system of FIG. 4.

In FIG. 7, in an image input step 200, images around a moving structure (heavy equipment) are input by a camera 102 mounted on the heavy equipment such as an excavator. In the image input step 200, a wide viewing angle is secured by using a fisheye lens. In addition, in the distortion correction step 201, the distortion caused by the use of the fisheye lens, so that the driver of the heavy equipment such as an excavator can further accurately monitor the surroundings of the heavy equipment such as an excavator.

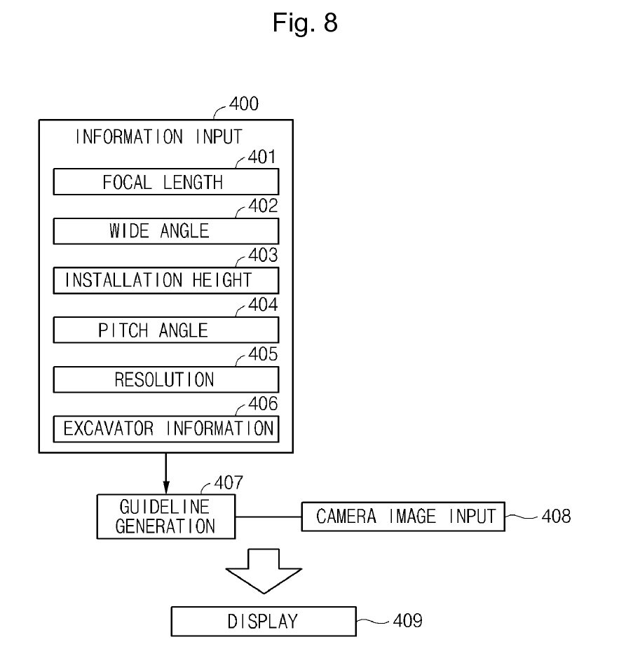

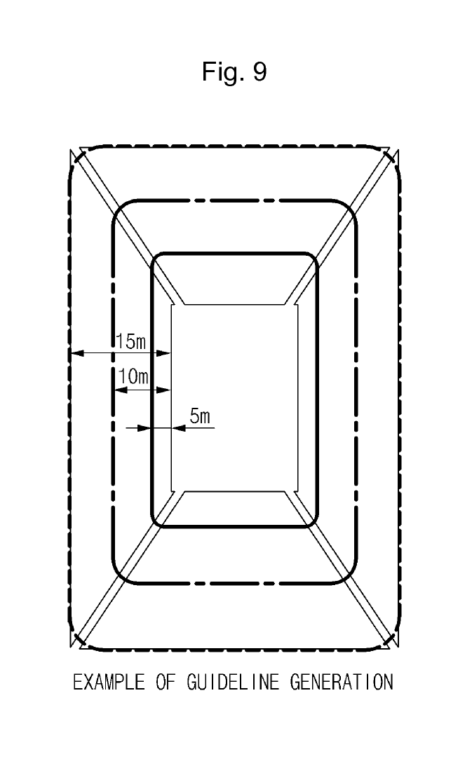

FIG. 8 is a schematic flowchart illustrating a step of generating guidelines in the top view image obtained in FIG. 6. In order to generate the guidelines, information on the heavy equipment such as an excavator and information on the camera are input. The guidelines are generated by using the information and illustrated in the top view image.

As illustrated in FIG. 8, an embodiment of the present invention includes a camera information input step of inputting the information on the camera mounted on the heavy equipment such an excavator, a barrel distortion correction step of correcting distortions of images based on the input information, an image integrated step of converting the corrected images into an image in a top view format, a guideline generation step for indicating an accurate distance, a warning of approaching step of indicating that there is an approaching object, and an image output step of outputting a completed image.

FIG. 9 is a view illustrating an example of generating guidelines in a top view image. Distances of the guidelines are set in an information input step. Colors and types of the guidelines are set differently according to the distances, so that a driver can intuitionally perceive the distances.

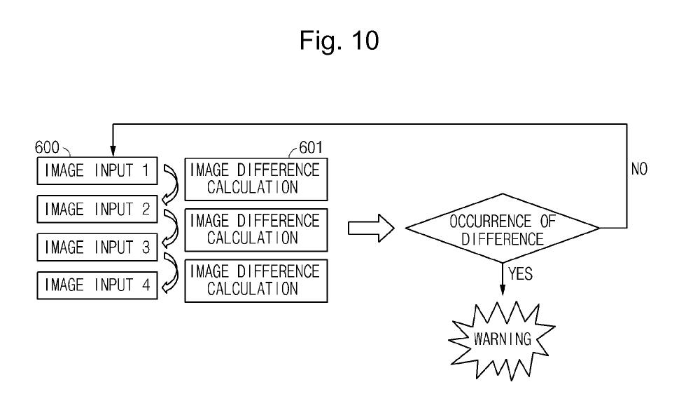

FIG. 10 is a schematic flowchart illustrating a warning of approaching step for warning of approaching of an object by using a difference between real-time input images. The step may be performed only when the heavy equipment such as an excavator is in the stopped state.

A difference between the pervious frame of image and the current frame of image is calculated. When a great difference occurs, an object is determined to approach, and the approaching of the object is notified to the driver.

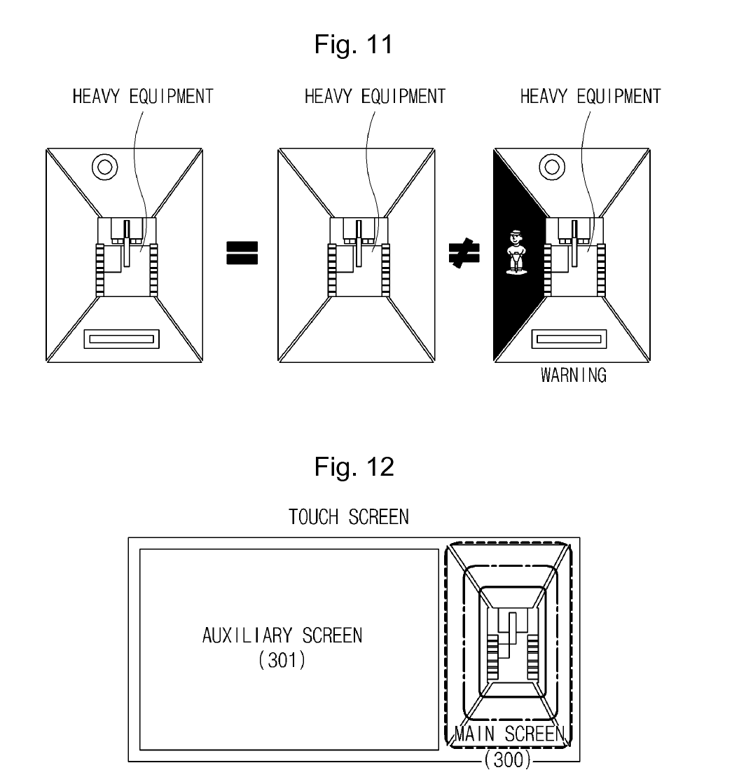

FIG. 11 is a schematic view illustrating an example of an approaching object determination unit which determines an approaching object. FIG. 12 is a view illustrating an example of a screen of a display for a manipulator.

Referring to FIG. 12, guidelines are illustrated in a top view image in a main screen. If the approaching of an object occur in one of the front, rear, left, and right images included in the top view image, the corresponding image is blinking, and a warning signal is issued. In addition, when the corresponding image among the front, rear, left, and right images displayed in the main screen is touched, the corresponding image can be separately displayed in the auxiliary screen. The front side and the rear side are automatically changed according to the proceeding direction of the vehicle, that is, the heavy equipment.

A touch screen is used as the screen of the display. In a main screen 300 of the display, a guideline is generated on the image in a top view format so as to indicate the distance. When a section of the screen corresponding to one of the cameras disposed at the four sides is touched, the image acquired by the corresponding camera can be perceived from an auxiliary screen 301.

The present invention relates to a monitoring apparatus as a technology of proving image information to the driver of the heavy equipment such as excavator through the cameras mounted on the heavy equipment such as an excavator, which outputs an image indicating a work radius of the heavy equipment such as an excavator in a top view format.

In the present invention, the barrel distorted images acquired from the wide angle cameras mounted on the heavy equipment such as an excavator are corrected, and an image in a top view format which is obtained from the corrected images at the speed of calculation improved by using the mapping table is provided, so that the driver can monitor the surroundings of the heavy equipment such as an excavator.

An embodiment of the prevention includes a camera information input step of inputting information on a camera; a barrel distortion correction step of correcting distortions of images acquired from cameras mounted on heavy equipment such as an excavator based on the input information; an image integrated step of integrating the corrected images; an integrated image conversion mapping table generation step for increasing a speed of calculation; and an image output step of providing an image in a top view format to a driver.

In an embodiment of the present invention, an image input unit 1100 is mounted on heavy equipment such as an excavator and inputs images around the moving heavy equipment. An image processing unit 1200 performs an image process of correcting distortions of images acquired by a plurality of cameras and removing blind zones of the cameras by using the corrected images and converts the processed images into a single top view image.

A guideline generation unit 1300 generates a guideline indicating a position separated by a predetermined distance from the image input unit on the image. An approaching warning unit 1600 measures differences between the input images. When the difference between the images occurs due to the approaching of the object, the approaching warning unit 1600 issues a warning of the approaching. An image output unit 1400 outputs the processed image on a screen so that a driver can check the image.

Since an image in a top view format without blind zones is provided to the driver of the heavy equipment such as an excavator, the driver sitting on the driver's seat can entirely monitor the surroundings of the heavy equipment such as an excavator and can accurately estimate the distance by using the generated guideline.

In addition, since the approaching warning unit notifies the approaching of an external object to the driver who may not perceive the approaching object, it is possible to prevent a satiety accident which may occur in the movement or working of the heavy equipment and to improve work efficiency without an assistant.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An equipment operation safety monitoring system comprising:
an image input unit which is mounted on heavy equipment and which inputs a plurality of images acquired by photographing partitioned areas in all the directions around the heavy equipment;
an integrated image generation unit which generates an integrated image including the areas in all the directions around the heavy equipment by using the plurality of the images;
a guideline generation unit which generates a guideline indicating a position separated by a predetermined distance from the heavy equipment; and
an image output unit which illustrates the guideline on the integrated image and outputs the integrated image.

2. The equipment operation safety monitoring system according to claim 1, wherein the integrated image generation unit generates the integrated image by correcting the input images according to a characteristic of the image input unit.

3. The equipment operation safety monitoring system according to claim 1, further comprising an approaching object determination unit which determines whether or not there is an object approaching the heavy equipment by comparing the images input by the image input unit with previously input images.

4. The equipment operation safety monitoring system according to claim 3, further comprising a warning signal output unit which outputs a warning signal in the case where the approaching object determined by the approaching object determination unit is within a predetermined distance from the heavy equipment.

5. The equipment operation safety monitoring system according to claim 2, wherein the integrated image generation unit generates the integrated image in a top view format as seen from the top of the heavy equipment.

6. The equipment operation safety monitoring system according to claim 1, wherein the guideline generation unit generates the guideline based on an installation height and angle of the image input unit.

7. An equipment operation safety monitoring method comprising:
an image input step of inputting a plurality of images acquired by photographing partitioned areas in all the directions around heavy equipment in an equipment operation safety monitoring system mounted on the heavy equipment;
an integrated image generation step of generating an integrated image including the areas in all the directions around the heavy equipment by using the plurality of the images;
a guideline generation step of generating a guideline indicating a position separated by a predetermined distance from the heavy equipment; and
an image output step of illustrating the guideline in the integrated image and outputting the integrated image.

8. The equipment operation safety monitoring method according to claim 7, wherein in the integrated image generation step, the integrated image is generated by correcting the input images according to a characteristic of an image input apparatus.

9. The equipment operation safety monitoring method according to claim 7, further comprising an approaching object determination step of determining whether or not there is an object approaching the heavy equipment by comparing the images input in the image input step with previously input images.

10. The equipment operation safety monitoring method according to claim 9, further comprising a warning signal output step of outputting a warning signal in the case where the approaching object determined in the approaching object determination step is within a predetermined distance from the heavy equipment.

11. The equipment operation safety monitoring method according to claim 8, wherein in the integrated image generation step, the integrated image is generated in a top view format as seen from the top of the heavy equipment.

12. The equipment operation safety monitoring method according to claim 7, wherein in the guideline generation step, the guideline is generated based on an installation height and angle of the image input apparatus.

13. A computer-readable medium having a program recorded thereon, the program allowing a computer to execute an equipment operation safety monitoring method, wherein the method comprising:
an image input step of inputting a plurality of images acquired by photographing partitioned areas in all the directions around heavy equipment in an equipment operation safety monitoring system mounted on the heavy equipment;
an integrated image generation step of generating an integrated image including the areas in all the directions around the heavy equipment by using the plurality of the images;
a guideline generation step of generating a guideline indicating a position separated by a predetermined distance from the heavy equipment; and
an image output step of illustrating the guideline in the integrated image and outputting the integrated image.

14. The computer-readable medium according to claim 13, wherein in the integrated image generation step, the integrated image is generated by correcting the input images according to a characteristic of an image input apparatus.

15. The computer-readable medium according to claim 13, further comprising an approaching object determination step of determining whether or not there is an object approaching the heavy equipment by comparing the images input in the image input step with previously input images.

16. The computer-readable medium according to claim 15, further comprising a warning signal output step of outputting a warning signal in the case where the approaching object determined in the approaching object determination step is within a predetermined distance from the heavy equipment.

17. The computer-readable medium according to claim 14, wherein in the integrated image generation step, the integrated image is generated in a top view format as seen from the top of the heavy equipment.

18. The computer-readable medium according to claim 13, wherein in the guideline generation step, the guideline is generated based on an installation height and angle of the image input apparatus.
